(19) United States
(12) Patent Application Publication
(10) Pub. No.: US 2024/0310972 A1
(43) Pub. Date: Sep. 19, 2024

(54) PLANNING METHOD AND PLANNING SYSTEM FOR DISPLAYING DEVICES

(71) Applicant: WINSTAR DISPLAY CO., LTD., Taichung City (TW)

(72) Inventors: YU-PIN LIAO, Taichung City (TW); CHIEN-CHOU HSU, Taichung City (TW); CHIA-HSIANG NI, Taichung City (TW); WEN-WEI CHUNG, Taichung City (TW); SSU-TSUNG CHEN, Taichung City (TW); YING-SHUN LIAO, Taichung City (TW); YEN-HUA LIAO, Taichung City (TW)

(73) Assignee: WINSTAR DISPLAY CO., LTD., Taichung City (TW)

(21) Appl. No.: 18/231,431

(22) Filed: Aug. 8, 2023

(30) Foreign Application Priority Data
Mar. 15, 2023 (TW) 112109478

(51) Int. Cl. G06F 3/0482; G06F 3/04847

(52) U.S. Cl. CPC G06F 3/0482; G06F 3/04847

(57) ABSTRACT

A planning method for a displaying device, comprising: read and decode a device description file with a host of a planning system; display a planning interface on a screen via the host; take an object configuration step to configure at least one graphical object to the at least one display page and set an object parameter of the at least one graphical object; generate a corresponding graphical user interface configuration file via the host. When the planning system is connected to the displaying device, the host transmits the graphical user interface configuration file to the displaying device. A microcontroller of the displaying device displays a corresponding graphical user interface on the displaying module based on the graphical user interface configuration file. In this way, the operation time for the user to plan the graphical user interface could be effectively saved.

### BACKGROUND OF THE INVENTION

### Technical Field

The present invention relates generally to a displaying device connected to a communication bus, and more particularly to a planning method and a planning system for displaying devices.

### Description of Related Art

Conventional displaying devices are usually connected to a control system for displaying an information of the control system for users. Taking a displaying device of a vehicle as an example, the displaying device is connected to and communicates with a control system of the vehicle to obtain an information of each of node devices of the control system, such as vehicle speed, oil temperature, battery power, etc., and displays the information with graphical objects. Typically, the communication between the displaying device and each of the node devices is conducted through a communication bus, such as the CAN-bus communication bus, wherein the CAN-bus transmission protocol has good anti-interference ability, which could enhance the stability of communication.

However, users need to write a code for a microcontroller of the displaying device to specify a correlation between the graphical objects on the displaying device and the node devices of the control system. For users who are not familiar with the decoding rules of the code and the graphical objects, it takes a considerable amount of time to write the code, resulting in poor work efficiency.

### BRIEF SUMMARY OF THE INVENTION

In view of the above, the primary objective of the present invention is to provide a planning method and a planning system for displaying devices, which could facilitate users to plan a graphical user interface on the displaying device.

The present invention provides a planning method for a displaying device, applied to a planning system and the displaying device, wherein the planning system includes a host, a screen, and a first transmission module; the displaying device comprises a microcontroller, a second transmission module, and a displaying module; the first transmission module communicates with the second transmission module through a communication bus; the communication bus is a CAN-bus or an RS-485; comprising steps of:
read a device description file with the host, wherein the device description file includes at least one description data of at least one node device, and the at least one description data includes a device identification code, a message name, and a signal name;
decode the device description file with the host to obtain the device identification code, the message name, and the signal name of the at least one description data of the at least one node device;
display a planning interface on the screen with the host, wherein the planning interface comprises a planning area having at least one display page;
take an object configuration step, which includes: configure at least one graphical object onto the at least one display page and set an object parameter of the at least one graphical object, wherein the object parameter includes the at least one description data of the at least one node device;
generate a graphical user interface configuration file correspondingly via the host based on the at least one graphical object and the at least one display page in the planning area, wherein the graphical user interface configuration file includes the at least one display page, the at least one graphical object, and the object parameter;
transmit the graphical user interface configuration file via the host through the first transmission module and the second transmission module to the microcontroller after the first transmission module is connected to the second transmission module;
write the graphical user interface configuration file to a storage module with the microcontroller, and display a graphical user interface correspondingly on the displaying module via the microcontroller based on the graphical user interface configuration file written to the storage module, wherein the graphical user interface includes the at least one display page and the at least one graphical object, and the at least one graphical object corresponds to the at least one node device based on the object parameter.

The present invention further provides a planning system, adapted to be connected to a displaying device, wherein the displaying device includes a second transmission module; the second transmission module communicates through a communication bus that is a CAN-bus or an RS-485; the planning system includes a host, a screen, and a first transmission module, wherein the host is electrically connected to the screen and the first transmission module, and the first transmission module is detachably connected to the second transmission module;
wherein the host is adapted to read a device description file including at least one description data of at least one node device, wherein the at least one description data includes a device identification code, a message name, and a signal name; the host decodes the device description file to obtain the device identification code, the message name, and the signal name of the at least one description data;
wherein the host executes an application and displays a planning interface on the screen, wherein the planning interface includes a planning area having at least one display page; the at least one graphical object is configured to the at least one display page by manipulating the host, and an object parameter of the at least one graphical object is set, wherein the object parameter includes the at least one description data of the at least one node device;
wherein the host correspondingly generates a graphical user interface configuration file based on the at least one display page and the at least one graphical object in the planning area, wherein the graphical user interface configuration file includes the at least one display page, the at least one graphical object, and the object parameter;
wherein the host outputs the graphical user interface configuration file through the first transmission module.

With the aforementioned design, the user could import a device description file into the host and use the host to plan the graphical objects required by the displaying device to form the graphical user interface, which could be convenient for the user to plan the graphical user interface and save the operation time for the user to plan the graphical user interface.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of the displaying device and the planning system according to a first embodiment of the present invention;

FIG. 2 is a schematic view, showing the displaying device according to the first embodiment of the present invention is connected to the node device through the communication bus;

FIG. 3 is a flowchart of the planning method of the displaying device according to the first embodiment of the present invention;

FIG. 4 is a schematic view, showing the planning interface displayed on the screen of the planning system according to the first embodiment of the present invention;

FIG. 5 is a schematic view, showing the setting parameter of the planning interface displayed on the screen of the planning system according to the first embodiment of the present invention;

FIG. 6 is a schematic view, showing the graphical user interface is correspondingly displayed on the displaying module of the displaying device according to the first embodiment of the present invention;

FIG. 7 is a schematic view, showing the emulator displayed on the screen of the planning system according to the first embodiment of the present invention;

FIG. 8 is a schematic view, showing the tester displayed on the screen of the planning system according to the first embodiment of the present invention;

FIG. 9 is a block diagram of the displaying device and the planning system according to a second embodiment of the present invention;

FIG. 10 is a schematic view, showing the planning interface displayed on the screen of the planning system according to the second embodiment of the present invention; and

FIG. 11 is a schematic view, showing the planning interface displayed on the screen of the planning system according to the second embodiment of the present invention.

### DETAILED DESCRIPTION OF THE INVENTION

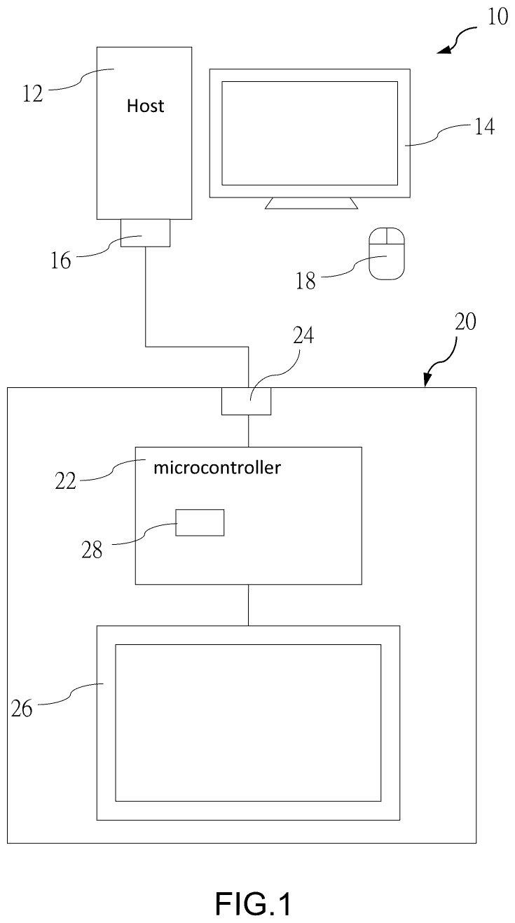

A planning system 10 and a displaying device 20 that apply a planning method of the displaying device 20 according to a first embodiment of the present invention is illustrated in FIG. 1, wherein the displaying device 20 is an embedded system, which could be applied in fields such as vehicles, machine tools, etc., such as automotive displaying devices, machine tool displaying devices, etc.

The planning system 10 includes a host 12, a screen 14, and a first transmission module 16, wherein the host 12 could be, for example, a computer host, which has a storage unit (e.g. a hard disc) therein for storing files. The host 12 is connected to an input module 18, wherein the input module 18 could be, for example, a mouse or a keyboard for a user to operate the host 12. The screen 14 and the first transmission module 16 are connected to the host 12. The first transmission module 16 communicates through a communication bus, wherein the communication bus is CAN-bus as an example. However, this is not a limitation of the present invention, the communication bus could be other communication buses in other embodiments (e.g. RS-485). The first transmission module 16 could be a signal converter for converting the signal between the host 12 and the communication bus.

The displaying device 20 includes a microcontroller 22, a second transmission module 24, and a displaying module 26, wherein the microcontroller 22 is electrically connected to both the second transmission module 24 and the displaying module 26. The second transmission module 24 communicates through the communication bus and is detachably and electrically connected to the first transmission module 16. The microcontroller 22 is electrically connected to a storage module 28. In the current embodiment, the storage module 28 is a flash memory as an example. However, this is not a limitation of the present invention, the storage module 28 could be other solid-state storage devices (e.g. a solid-state drive) in other embodiments. In the current embodiment, the storage module 28 is built into the microcontroller 22 as an example. However, this is not a limitation of the present invention, the microcontroller 22 and the storage module 28 could be individually provided. The storage module 28 has a code section and a data section, wherein the code section is adapted to store code to be executed by the microcontroller 22, and the data section is adapted to store data such as images displayed on the displaying module, files of graphical objects, object parameters, etc. The displaying module 26 could be, for example, a touchscreen display.

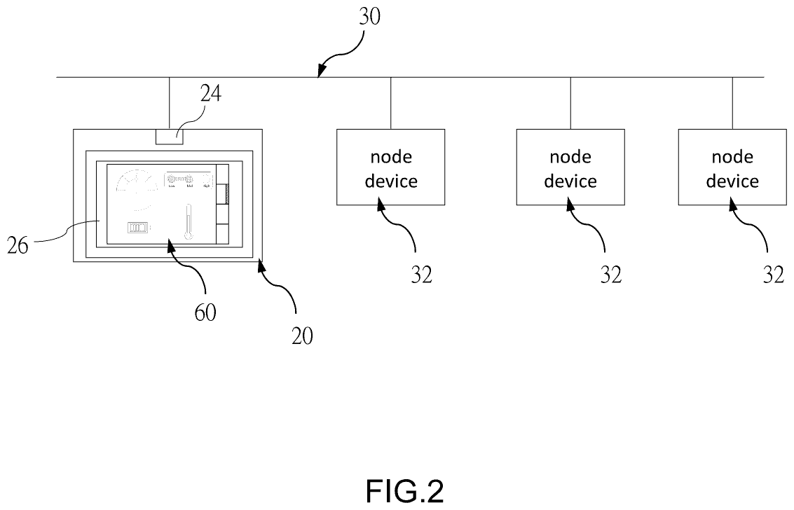

When the second transmission module 24 is disconnected from the first transmission module 16, the displaying device 20 could operate individually. For instance, referring to FIG. 2, the second transmission module 24 of the displaying device 20 is connected to and communicates with at least one node device 32 through the communication bus 30.

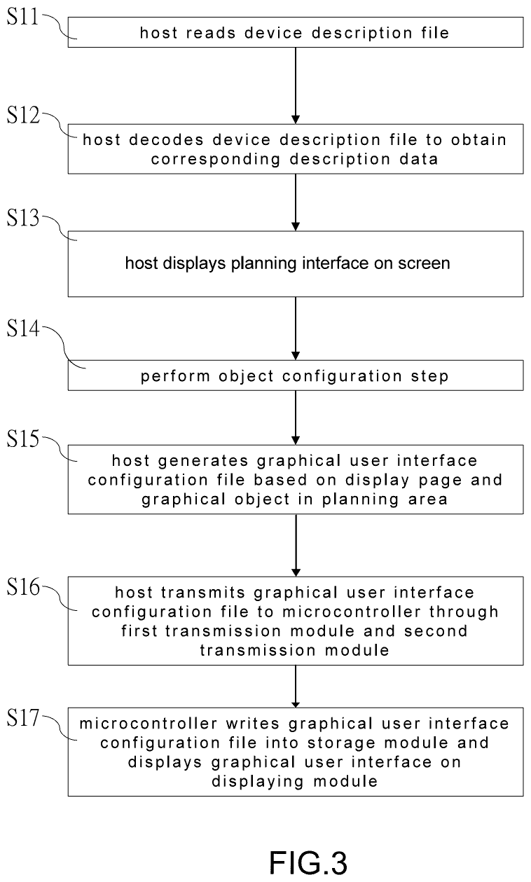

With the aforementioned design, the planning method of the displaying device 20 of the current embodiment could be taken, which includes following steps as shown in FIG. 3.

Step S11: the host 12 read a device description file, wherein the device description file includes at least one description data of the at least one node device 32; the at least one description data includes a device identification code, a message name, and a signal name.

In the current embodiment, the device description file is a DBC file (CAN database file) as an example, wherein the DBC file is an ASCII plain text file that contains various information about physical signals transmitted on the CAN-bus, including CAN IDs, message names, signal names, conversion ratios, definition, etc. The DBC file could be used to decode raw CAN data into meaningful physical values and map different CAN IDs to the corresponding signal. In other words, the DBC file provides the information required to convert an effective payload of a CAN-bus message into the physical value. In this way, the user could create and edit the DBC file by using a conventional DBC editor.

Step S12: the host 12 decodes the device description file to obtain the device identification code, the message name, and the signal name of the at least one description data corresponding to the at least one node device 32.

For instance, as shown in Table 1 below, which is an example of the description data decoded from the DBC file by the host 12, including a device identification code (CAN ID), a message name, a signal name, and decoding information of a node device 32. The decoding information includes start bit, length, factor, offset, and unit. In other words, this description data contains decoding rules for the signals.

TABLE 1
Description Data

| | |
|---|---|
| Device identification code (CAN ID) | 0x181 |
| Message Name | EEC1 |
| Signal Name | EngSpeed |
| Start Bit | 24 |
| Length | 16 bits |
| Factor | 0.125 |
| Offset | 0 |
| Unit | rpm |

The host 12 records the one or more description data obtained by decoding in a list.

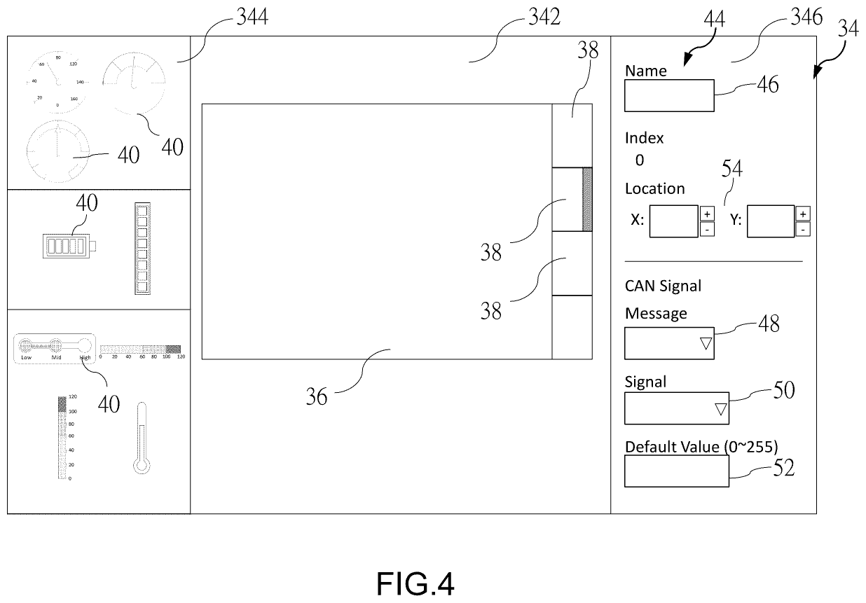

Step S13: the host 12 displays a planning interface 34 on the screen 14 (as shown in FIG. 4), wherein the planning interface 34 includes a planning area 342 having at least one display page 36.

In the current embodiment, the host 12 executes an application for planning the displaying device 20 to display the planning interface 34. Users could add at least one display page 36 in the planning interface 34. One of four display pages is shown in FIG. 4, and other display pages could be switched and displayed through a corresponding page tab 38.

In the current embodiment, the planning interface 34 further includes an object area 344 and a parameter setting area 346, wherein the object area 344 has a plurality of predetermined graphical objects 40 for the user to choose as at least one graphical object 56 desired to display, and the parameter setting area is adapted to display a parameter of the graphical object 56 desired to be configured.

Step S14: perform an object configuration step including following steps.

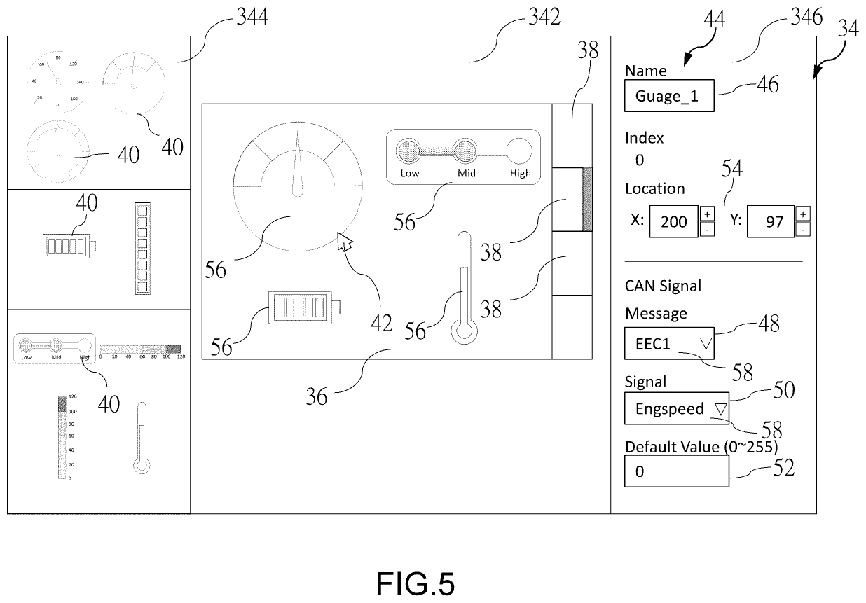

Referring to FIG. 5, configure the at least one graphical object 56 on the at least one display page 36, and set an object parameter of the at least one graphical object 56, wherein the object parameter includes the at least one description data of the at least one node device 32.

In the current embodiment, the user could operate the host 12 to select at least one of the predetermined graphical objects 40 from the object area 344 and drag it to a predetermined position on the at least one display page 36 in the planning area 342 to form the graphical object 56. In FIG. 5, multiple of the predetermined graphical objects 40 are dragged to different predetermined positions on the display page 36 to form multiple graphical objects 56.

When the user selects any one of the graphical objects 56 with a pointer 42 in the planning area 342 of the planning interface 34, the host 12 displays a plurality of parameter options 44, which could be set for the graphical object 56 selected, in the parameter setting area 346, wherein the parameter options 44 include an object name option 46, a message name option 48, a signal name option 50, and a default value option. When the message name option 48 and the signal name option 50 are selected, the host 12 correspondingly displays a menu 58 in the parameter setting area 346 (e.g. a dropdown menu), wherein the menu 58 links to the list that records the corresponding at least one description data, allowing the user to select the corresponding at least one description data from the list. The host 12 then sets the at least one description data selected to the object parameter of the selected graphical object 56.

The parameter options 44 further includes a position adjusting option 54 for the user to set an X value and a Y value of the position adjusting option 54, thereby fine-tuning an object position of the graphical object 56. If no adjustment is needed, the predetermined position of the graphical object 56 is used as the object position. Afterward, the host 12 records the object position of the selected graphical object 56 on the display page 36.

Step S15: the host 12 correspondingly generates a graphical user interface configuration file based on the at least one graphical object 56 and the display page 36 in the planning area 342, wherein the graphical user interface configuration file includes the display page 36, the at least one graphical object 56, and the object parameter of the at least one graphical object 56.

In the current embodiment, the graphical user interface configuration file generated by the host 12 further includes data of the object position of each of the graphical objects 56.

In the current embodiment, the host 12 could compress the graphical user interface configuration file to reduce a file size of the graphical user interface configuration file, wherein the file compression here does not involve lossy or lossless compression of the images, but compresses the entire graphical user interface configuration file into one or more compressed files, such as Zip, RAR, 7z, etc.

After that, when planning for the displaying device 20, the second transmission module 24 of the displaying device 20 to be planned is connected to the first transmission module 16 of the planning system 10 via a physical cable.

Step S16: when the first transmission module 16 is connected to the second transmission module 24, the host 12 transmits the graphical user interface configuration file through the first transmission module 16 and the second transmission module 24 to the microcontroller 22.

In the current embodiment, the first transmission module 16 communicates with the second transmission module 24 through the CAN-bus, wherein due to a transmission bandwidth of the CAN-bus being approximately 1 Mbps, in order to reduce a transmission time of the graphical user interface configuration file, the host 12 sends a compressed file of the graphical user interface configuration file through the first transmission module 16 and the second transmission module 24 to the microcontroller 22, thus reducing a time of transmitting data. In practice, if the limitation of the transmission bandwidth is not considered, the graphical user interface configuration file uncompressed could also be transmitted.

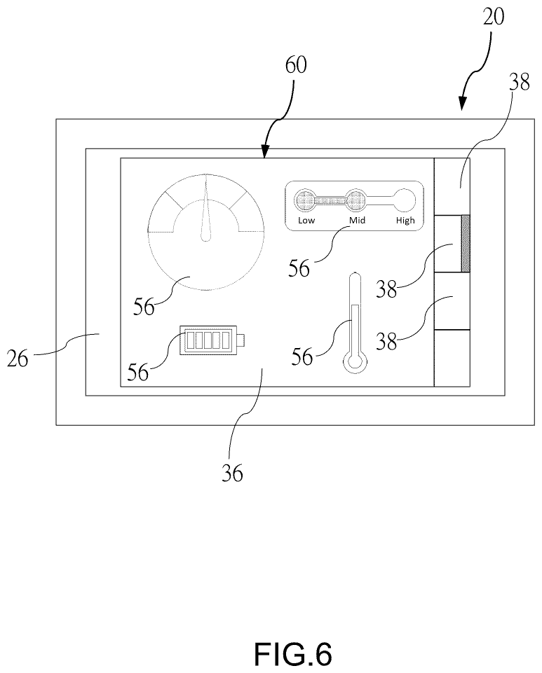

Step S17: the microcontroller 22 writes the graphical user interface configuration file to the storage module 28 and correspondingly displays a graphical user interface 60 on the displaying module 26 based on the graphical user interface configuration file written to the storage module 28 (as shown in FIG. 6), wherein the graphical user interface 60 includes the at least one display page 36 and the at least one graphical object 56, and the at least one graphical object 56 corresponds to the at least one node device 32 via the object parameter of the at least one graphical object 56.

In the current embodiment, the microcontroller 22 decompresses the compressed file of the graphical user interface configuration file and writes the graphical user interface configuration file to the data section of the storage module 28, and correspondingly displays the graphical user interface 60 on the displaying module 26 based on the graphical user interface configuration file, wherein when the microcontroller 22 displays the graphical user interface 60 on the displaying module 26, the microcontroller 22 arranges each of the graphical objects 56 on the display page 36 based on the data of the object position of each of the graphical objects 56.

When the second transmission module 24 is disconnected from the first transmission module 16, the displaying device 20 could individually operate to display the graphical user interface 60.

Referring to FIG. 2, in subsequent applications, the displaying device 20 is electrically connected to and communicates with other node devices 32 via the communication bus 30. When the microcontroller 22 of the displaying device 20 receives CAN raw data through the second transmission module 24, such as the device identification code (CAN ID): “0x181”, and data bytes: “FF FF FF 80 3E FF FF”, the microcontroller 22 calculates the physical value with at least one defined formula by using the object parameters obtained from the description data decoded from the DBC file as defined in Table 1, wherein the calculation could be executed by the code of the microcontroller 22. For example, the physical value could be calculated with the following formula (1)

$$Physical\_value = Offset + Factor \times Raw\_value \_dec \qquad ( 1 )$$

wherein Offset and Factor are respectively a coefficient and an offset; Raw_value_dec is a decimal value (i.e., 16000) of 0x3E80 extracted from the CAN raw data based on the object parameter. The physical value could be calculated as follow.

$$Physical\_value = 0 + 0.125 \times 16000 = 2000$$

In this way, a decoding result obtained by the microcontroller 22 after decoding the CAN raw data based on the object parameter in the description data defined in Table 1 is shown in Table 2.

TABLE 2
Decoding result

| Message name | Signal name | Physical_value | Unit |
|---|---|---|---|
| ECC1 | EngSpeed | 2000 | rpm |

The microcontroller 22 could display the decoding result on the corresponding graphical object, for example, changing a position of a pointer of the graphical object 56 represents the physical value, allowing the graphical object 56 on the graphical user interface 60 to correspondingly display the signal sent by the node device 32. In practice, the physical value of the decoding result could be displayed on the corresponding graphical object 56 by using Object Dictionary of CANopen protocol, wherein the physical value could be displayed as a graphical representation or a numerical value.

In the current embodiment, a simulation step is included before step S16, which is adapted to display the graphical user interface 60 on the screen 14 based on the graphical user interface configuration file generated in step S15 for the user to simulate the graphical user interface configured.

More specifically, the simulation step includes following steps.

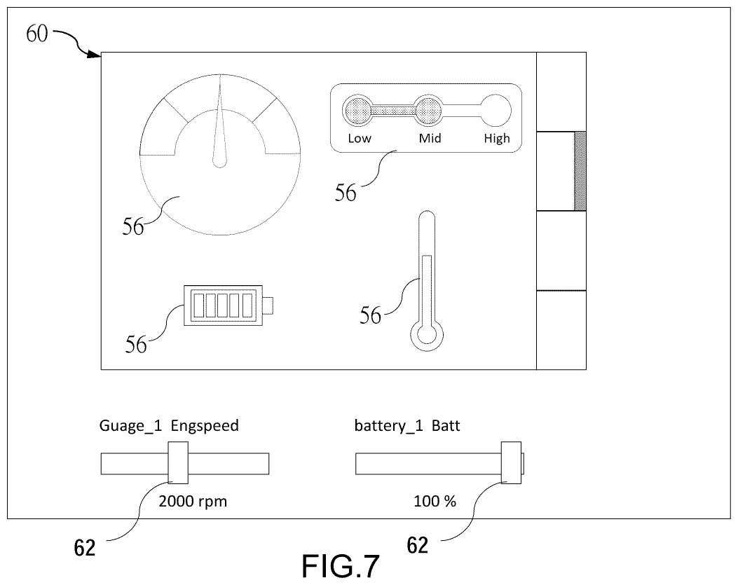

The host 12 displays a simulator on the screen 14 (as shown in FIG. 7), wherein the simulator includes the graphical user interface 60 generated based on the graphical user interface configuration file and a simulated input interface corresponding to the at least one node device 32.

Two simulated input interfaces 62 that are slide bars as an example are shown in FIG. 7, wherein each of the simulated input interfaces 62 is used to generate a simulated input data. A format of the simulated input data is a raw data (i.e., the CAN raw data) of a communication bus.

The host 12 displays the decoding result on the corresponding graphical object 56 in the simulator based on the object parameter of the corresponding graphical object 56 according to the simulated input data. That is, the simulated input data is decoded based on the object parameter of the corresponding graphical object 56, and the decoding result is displayed on the corresponding graphical object 56.

In the current embodiment, a test step could be further included after step S17, which allows the user to test the graphical user interface 60 displayed on the displaying device 20.

More specifically, the test step includes following steps.

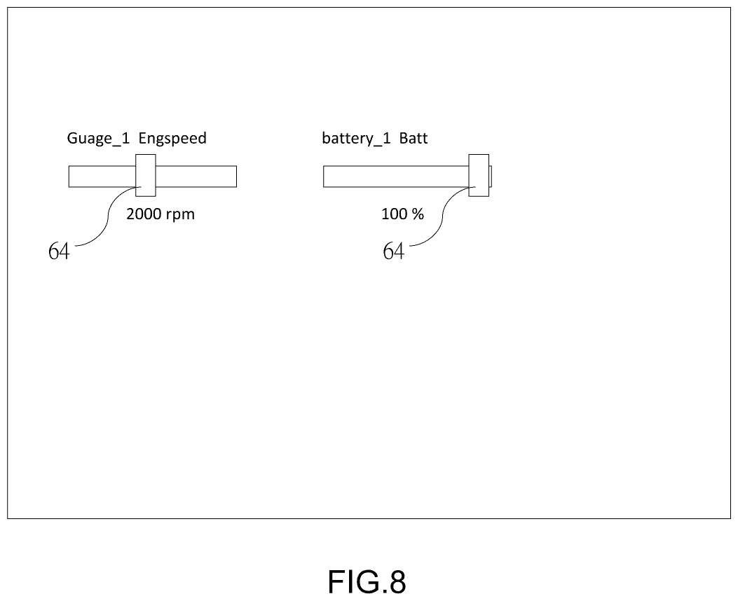

The host 12 displays tester on the screen 14 as shown in FIG. 8, wherein the tester includes a test input interface 64 corresponding to the at least one node device 32.

Two test input interfaces 64 that are slide bars as an example are shown in FIG. 8, wherein each of the test input interfaces 64 is used to generate a test input data. A format of the test input data is a raw data (i.e., the CAN raw data) of a communication bus.

The host 12 transmits the test input data through the first transmission module 16 and the second transmission module 24 to the microcontroller 22, and the microcontroller 22 correspondingly displays the graphical object 56 of the graphical user interface 60 in the displaying module 26 based on the test input data received. That is, the microcontroller 22 decodes the test input data based on the object parameter of the corresponding graphical object 56 and displays the decoding result on the corresponding graphical object 56 as a graph and/or a value.

With the planning method and the planning system 10 of the current embodiment, the user could import the device description file pre-edited into the host 12 and use the host 12 to plan the graphical object 56 required for the displaying device 20 to form the graphical user interface, and the graphical user interface configuration file could be then transmitted to the displaying device 20 to effectively associate the graphical object 56 with the device identification code of the node device 32, facilitating the user in planning the graphical user interface 60.

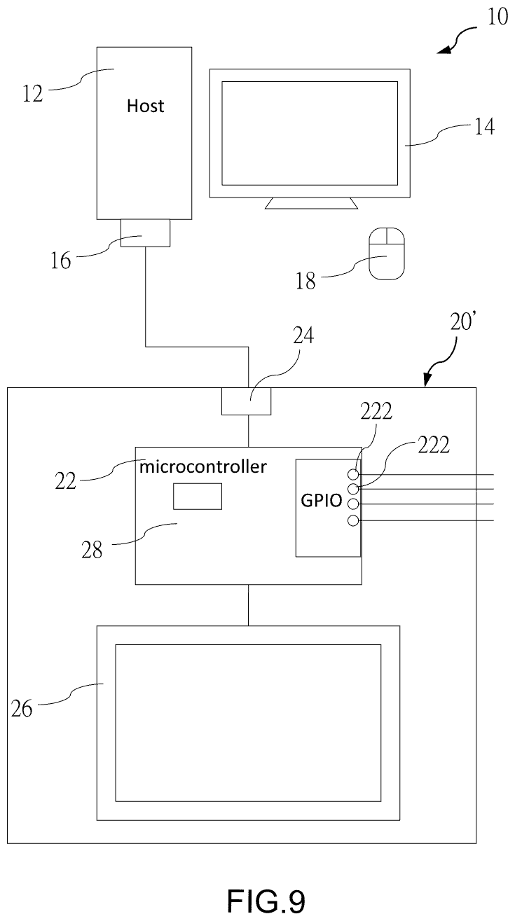

A planning system 10 and a displaying device 20′ that are applied to a planning method of the displaying device 20′ according to a second embodiment of the present invention is illustrated in FIG. 9, which is based on that of the first embodiment, wherein a microcontroller 22 of the displaying device 20′ of the current embodiment includes at least one general-purpose input/output (GPIO) pin 222 adapted to be connected to an output member or an input member (not shown). The output member could be, for example, a switch, a sensor, etc., while the input member could be, for example, an LED, a light, a buzzer, an actuator, etc. In the current embodiment, the at least one general-purpose input/output pin 222 includes a plurality of general-purpose input/output pins 222.

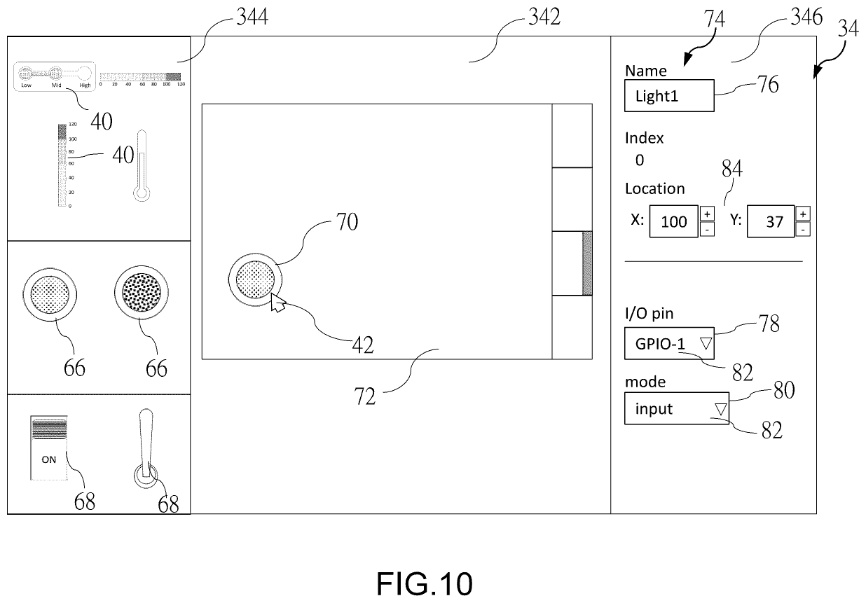

A planning method of the displaying device 20′ is based on that of the first embodiment, which further includes an input graphical object setting step and/or an output graphical object setting step in the object configuration step of step S14, which are optional steps depending on the user's choice to set either the input graphical object or the output graphical object. Referring to FIG. 10, the object area 344 has a plurality of predetermined input graphical objects 66 (such as images of the indicator light) and a plurality of predetermined output graphical objects 68 (such as images of the switch).

The input graphical object setting step includes following steps.

Configure at least one input graphical object 70 onto the at least one display page and set an input object parameter of the at least one input graphical object 70, wherein the input object parameter corresponds to the at least one general-purpose input/output pin 222 specified.

Referring to FIG. 10, the user could select the predetermined input graphical object 66 desired (e.g. the indicator light) and drag it onto the display page 36 to form the input graphical object 70, wherein the display page 36 could be a new display page 72 or the display page 36 of the first embodiment.

The host 12 displays a plurality of parameter options 74, which could be set for the predetermined input graphical object 66 selected, in the parameter setting area, wherein the parameter options 74 include an object name option 46, a pin option 78, and a mode option 80. When the pin option 78 and the mode option 80 are selected, the host 12 displays a corresponding menu 82 in the parameter setting area 346, such as a drop-down menu, which links to an input/output list for the user to select the corresponding pin data. For example, selecting GPIO-1 for the pin option 78 designates the first general-purpose input/output pin, and selecting input for the mode option 80 designates an input mode. The host 12 sets the pin data selected to the input object parameter of the input graphical object 70 selected, wherein the parameter options 74 may also include a position adjusting option 84.

After that, in step S15, the host 12 correspondingly generates the graphical user interface configuration file based on the at least one display page 36, the at least one graphical object 56, and the at least one input graphical object 70 in the planning area 342, wherein the graphical user interface configuration file includes the at least one display page 36, the at least one graphical object 56, the object parameter of the at least one graphical object 56, the at least one input graphical object 70, and the input object parameter of the at least one input graphical object 70.

In step S17, the graphical user interface 60 that the microcontroller 22 displays on the displaying module 26 further includes the input graphical object 70, wherein the at least one input graphical object 70 corresponds to the at least one general-purpose input/output pin 222 based on the input object parameter of the at least one input graphical object 70.

For instance, when the first general-purpose input/output pin is connected to the output member and the output member outputs a high or low voltage level to the first general-purpose input/output pin, the microcontroller 22 correspondingly displays the input graphical object 70 based on the input object parameter of the corresponding input graphical object 70. For example, when a high voltage level is inputted, the input graphical object 70 is displayed as a lit light; when a low voltage level is inputted, the input graphical object 70 is displayed as extinguished.

The output graphical object setting step includes following steps.

Configure at least one output graphical object 86 onto the at least one display page and set an output object parameter of the at least one output graphical object 86, wherein the output object parameter corresponds to the at least one general-purpose input/output pin 222 specified.

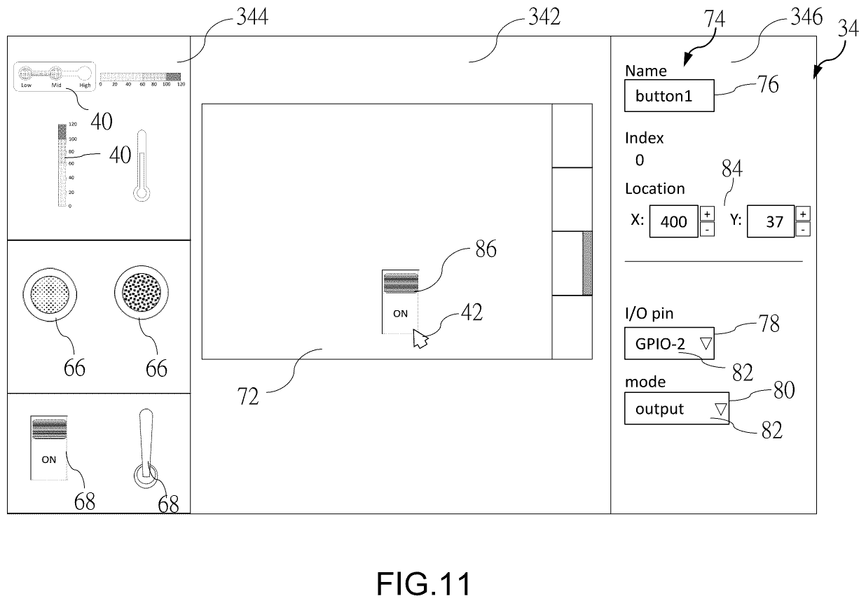

Referring to FIG. 11, the user could select the predetermined output graphical objects 68 desired (e.g. a switch) and drag it onto the display page 72 to form the output graphical object 86, wherein the display page 36 could be the new display page 72 or the display page 36 of the first embodiment.

The host 12 displays a plurality of parameter options, which could be set for the predetermined output graphical objects 68 selected, in the parameter setting area 346, wherein the parameter options include an object name option 46, a pin option 78, and a mode option 80. When the pin option 78 and the mode option 80 are selected, the host 12 displays a corresponding menu 82 in the parameter setting area 346, such as a drop-down menu, which links to the input/output list for the user to select the corresponding pin data. For example, selecting GPIO-2 for the pin option designates a second general-purpose input/output pin, and selecting output for the mode option designates an output mode. The host 12 sets the pin data selected to the output object parameter of the output graphical object 86.

After that, in step S15, the host 12 correspondingly generates the graphical user interface configuration file based on the at least one display page 36, the at least one graphical object 56, and the at least one output graphical object 86 in the planning area 342, wherein the graphical user interface configuration file includes the at least one display page 36, the at least one graphical object 56, the object parameter of the at least one graphical object 56, the output graphical object 86, and the output object parameter of the output graphical object 86.

In step S17, the graphical user interface 60 that the microcontroller 22 displays on the displaying module 26 further includes the output graphical object 86, wherein the at least one output graphical object 86 corresponds to the at least one general-purpose input/output pin 222 based on the output object parameter of the at least one output graphical object 86.

For instance, when the second general-purpose input/output pin is connected to an input member and the user selects the output graphical object 86 on the displaying module 26, the microcontroller 22 outputs a high voltage level or a low voltage level through the second general-purpose input/output pin based on the output object parameter, thus the operation of the external input member could be controlled.

Similarly, the object position of the input graphical object 70 or the output graphical object 86 of the current embodiment could also be set with the position adjusting option 84, to be displayed on the display page 36.

In summary, with the planning method and the planning system of the current embodiment, the user could effectively plan and associate the one or more general-purpose input/output pins of the microcontroller 22 with the input graphical object 70 and/or the output graphical object 86.

It must be pointed out that the embodiments described above are only some preferred embodiments of the present invention. All equivalent structures and methods which employ the concepts disclosed in this specification and the appended claims should fall within the scope of the present invention.

What is claimed is:

1. A planning method for a displaying device, applied to a planning system and the displaying device, wherein the planning system comprises a host, a screen, and a first transmission module; the displaying device comprises a microcontroller, a second transmission module, and a displaying module; the first transmission module communicates with the second transmission module through a communication bus; the communication bus is a CAN-bus or an RS-485; comprising steps of:
reading a device description file with the host, wherein the device description file comprises at least one description data of at least one node device, and the at least one description data comprises a device identification code, a message name, and a signal name;
decoding the device description file with the host to obtain the device identification code, the message name, and the signal name of the at least one description data of the at least one node device;
displaying a planning interface on the screen with the host, wherein the planning interface comprises a planning area having at least one display page;
performing an object configuration step, which comprises: configuring at least one graphical object onto the at least one display page and setting an object parameter of the at least one graphical object, wherein the object parameter comprises the at least one description data of the at least one node device;
generating a graphical user interface configuration file correspondingly via the host based on the at least one graphical object and the at least one display page in the planning area, wherein the graphical user interface configuration file comprises the at least one display page, the at least one graphical object, and the object parameter;
transmitting the graphical user interface configuration file via the host through the first transmission module and the second transmission module to the microcontroller after the first transmission module is connected to the second transmission module; and
writing the graphical user interface configuration file to a storage module with the microcontroller, and displaying a graphical user interface correspondingly on the displaying module via the microcontroller based on the graphical user interface configuration file written to the storage module, wherein the graphical user interface comprises the at least one display page and the at least one graphical object, and the at least one graphical object corresponds to the at least one node device based on the object parameter.

2. The planning method as claimed in claim 1, wherein the planning interface comprises an object area having a plurality of predetermined graphical objects; the object configuration step further comprises: selecting at least one of the plurality of predetermined graphical objects to form the at least one graphical object.

3. The planning method as claimed in claim 2, wherein in the object configuration step, the host records an object position of the at least one graphical object on the at least one display page; the graphical user interface configuration file generated by the host comprises data of the object position of the at least one graphical object; the microcontroller displays the graphical user interface on the displaying module by configuring the at least one graphical object on the at least one display page based on the data of the object position.

4. The planning method as claimed in claim 1, wherein the host records the at least one description data in a list; the planning interface comprises a parameter setting area; in the object configuration step, when the at least one graphical object in the planning area of the planning interface is selected, the host correspondingly displays a menu in the parameter setting area; the menu links to the list; the host sets the at least one description data in the list to the object parameter.

5. The planning method as claimed in claim 1, further comprising a simulation step, comprising: displaying a simulator on the screen with the host, wherein the simulator comprises the graphical user interface generated based on the graphical user interface configuration file and a simulated input interface corresponding to the at least one node device; the simulated input interface is adapted to generate a simulated input data; displaying the at least one graphical object in the simulator correspondingly via the host based on the object parameter according to the simulated input data.

6. The planning method as claimed in claim 1, further comprising a test step, comprising: displaying a tester on the screen via the host, wherein the tester comprises a test input interface corresponding to the at least one node device; the test input interface is adapted to generate a test input data; transmitting the test input data via the host through the first transmission module and the second transmission module to the microcontroller, and displaying the at least one graphical object of the graphical user interface in the displaying module correspondingly via the microcontroller based on the test input data received.

7. The planning method as claimed in claim 1, wherein the microcontroller of the displaying device comprises at least one general-purpose input/output pin; the object configuration step further comprises: configuring at least one input graphical object onto the at least one display page and setting an input object parameter of the at least one input graphical object, wherein the input object parameter corresponds to the at least one general-purpose input/output pin specified; generating the graphical user interface configuration file correspondingly via the host based on the at least one display page, the at least one graphical object, and the at least one input graphical object in the planning area, wherein the graphical user interface configuration file comprises the at least one display page, the at least one graphical object, the object parameter, the input graphical object, and the input object parameter; the graphical user interface that the microcontroller displays on the displaying module further comprises the input graphical object, and the at least one input graphical object corresponds to the at least one general-purpose input/output pin based on the input object parameter.

8. The planning method as claimed in claim 1, wherein the microcontroller of the displaying device comprises at least one general-purpose input/output pin; the object configuration step further comprises: configuring at least one output graphical object onto the at least one display page and setting an output object parameter of the at least one output graphical object, wherein the output object parameter corresponds to the at least one general-purpose input/output pin specified; generating the graphical user interface configuration file correspondingly via the host based on the at least one display page, the at least one graphical object, and the at least one output graphical object in the planning area, wherein the graphical user interface configuration file comprises the at least one display page, the at least one graphical object, the object parameter, the output graphical object, and the output object parameter; the graphical user interface that the microcontroller displays on the displaying module further comprises the output graphical object, and the at least one output graphical object corresponds to the at least one general-purpose input/output pin based on the output object parameter.

9. A planning system, adapted to be connected to a displaying device, wherein the displaying device comprises a second transmission module; the second transmission module communicates through a communication bus that is a CAN-bus or an RS-485; the planning system comprises a host, a screen, and a first transmission module, wherein the host is electrically connected to the screen and the first transmission module, and the first transmission module is detachably connected to the second transmission module; the planning system is characterized in that:
the host is adapted to read a device description file comprising at least one description data of at least one node device, wherein the at least one description data comprises a device identification code, a message name, and a signal name; the host decodes the device description file to obtain the device identification code, the message name, and the signal name of the at least one description data;
the host executes an application and displays a planning interface on the screen, wherein the planning interface comprises a planning area having at least one display page;
the at least one graphical object is configured to the at least one display page by manipulating the host, and an object parameter of the at least one graphical object is set, wherein the object parameter comprises the at least one description data of the at least one node device;
the host correspondingly generates a graphical user interface configuration file based on the at least one display page and the at least one graphical object in the planning area, wherein the graphical user interface configuration file comprises the at least one display page, the at least one graphical object, and the object parameter; and
the host outputs the graphical user interface configuration file through the first transmission module.

10. The planning system as claimed in claim 9, wherein the planning interface comprises an object area having a plurality of predetermined graphical objects; at least one of the predetermined graphical objects is selected by manipulating the host to form the at least one graphical object.

11. The planning system as claimed in claim 10, wherein the host records an object position of the at least one graphical object on the at least one display page; the graphical user interface configuration file generated by the host comprises data of the object position of the at least one graphical object.

12. The planning system as claimed in claim 9, wherein the host records the at least one description data in a list; the planning interface comprises a parameter setting area;
when the at least one graphical object in the planning area of the planning interface is selected, the host displays a menu in the parameter setting area, wherein the menu links to the list to set the description data in the list to the object parameter.

13. The planning system as claimed in claim 9, wherein the host displays a simulator on the screen; the simulator comprises a simulated input interface corresponding to the at least one node device and a graphical user interface generated based on the graphical user interface configuration file; the simulated input interface is adapted to generate a simulated input data; the host displays the at least one graphical object in the simulator correspondingly based on the object parameter according to the simulated input data.

14. The planning system as claimed in claim 9, wherein the host displays a tester on the screen; the tester comprises a test input interface corresponding to the at least one node device; the test input interface is adapted to generate a test input data; the host outputs the test input data through the first transmission module.

15. The planning system as claimed in claim 9, wherein the displaying device comprises at least one general-purpose input/output pin; at least one input graphical object is configured to the at least one display page by manipulating the host, and an input object parameter of the at least one input graphical object is set, wherein the input object parameter corresponds to the at least one general-purpose input/output pin specified; the host correspondingly generates the graphical user interface configuration file based on the at least one display page, the at least one graphical object, and the at least one input graphical object in the planning area; the graphical user interface configuration file comprises the at least one display page, the at least one graphical object, the object parameter, the at least one input graphical object, and the input object parameter.

16. The planning system as claimed in claim 9, wherein the microcontroller of the displaying device comprises at least one general-purpose input/output pin; the at least one output graphical object is configured to the at least one display page by manipulating the host, and an output object parameter of the at least one output graphical object is set, wherein the output object parameter corresponds to the at least one general-purpose input/output pin specified; the host correspondingly generates the graphical user interface configuration file based on the at least one display page, the at least one graphical object, and the at least one output graphical object in the planning area; the graphical user interface configuration file comprises the at least one display page, the at least one graphical object, the object parameter, the at least one output graphical object, and the output object parameter.
